(19) United States
(12) Patent Application Publication
(10) Pub. No.: US 2026/0253773 A1
(43) Pub. Date: Aug. 27, 2026

(54) SUPERCONDUCTING MAGNETS

(71) Applicant: CANON MEDICAL SYSTEMS CORPORATION, Otawara-shi (JP)

(72) Inventor: Tatsuya INOUE, Kakogawa (JP)

(73) Assignee: CANON MEDICAL SYSTEMS CORPORATION, Otawara-shi (JP)

(21) Appl. No.: 19/545,570

(22) Filed: Feb. 20, 2026

(30) Foreign Application Priority Data
Feb. 26, 2025 (JP) 2025-029330
Oct. 2, 2025 (JP) 2025-166170

(51) Int. Cl. H01F 6/04; H01F 6/06

(52) U.S. Cl. CPC H01F 6/04; H01F 6/06

(57) ABSTRACT

A superconducting magnet of an embodiment includes a cryogenic part, a heat shield, a thermal resistance part, and a heat capacity part. The thermal resistance part is connected to a contacted part that is the cryogenic part or the heat shield. The heat capacity part connected to the thermal resistance part and has a thermal contraction rate different from that of the contacted part. The heat capacity part is in thermal contact with the contacted part to a first degree at a first temperature. The heat capacity part is not in contact with the contacted part or is in thermal contact with the contacted part to a second degree less than the first degree at a second temperature higher than the first temperature. The thermal resistance part has a thermal resistance greater than that of a portion of the contacted part to which the thermal resistance part is connected.

### CROSS-REFERENCE TO RELATED APPLICATION

The present application claims priority based on Japanese Patent Application No. 2025-029330 filed Feb. 26, 2025 and Japanese Patent Application No. 2025-166170 filed Oct. 2, 2025, the content of which is incorporated herein by reference.

### FIELD

Embodiments disclosed in this specification and drawings relate to superconducting magnets.

### BACKGROUND

Superconducting magnets for use in magnetic resonance imaging (MRI) devices and the like are known (refer to Patent Document 1, for example). A superconducting magnet includes, for example, a superconducting coil and a heat shield covering the superconducting coil. The superconducting coil is cooled to cryogenic temperatures by a cooling part. An example of a cooling part is a refrigerator system including an expander (cold head) and a compressor.

If the cooling part does not operate properly, such as when the power supply for driving the cooling part is lost due to a power outage, heat penetration causes the temperatures of the heat shield and the superconducting coil to increase. In this case, recooling will be necessary before quenching or re-energization may become necessary, which takes time. While using an uninterruptible power supply or like may be considered in preparation for a power outage, the period during which the power supply is capable of withstanding a power outage is limited depending on the capacity of the power supply, and beyond that period, the above-mentioned problems will recur.

A method of increasing the heat capacity of the heat shield and the superconducting coil is considered to suppress temperature increase in the heat shield and the superconducting coil. However, increasing the heat capacity of the heat shield and the superconducting coil means that the time required to cool the heat shield and the superconducting coil increases. This reduces the cooling efficiency of the superconducting magnet.

### BRIEF DESCRIPTION OF THE DRAWINGS

FIG. 1 is a diagram showing a superconducting magnet 1 according to a first embodiment.

FIG. 2 is a cross-sectional view taken along line II-II shown in FIG. 1.

FIG. 3 is a cross-sectional view showing the superconducting magnet 1 after cryogenic cooling.

FIG. 4 is an enlarged view of an area AR1 shown in FIG. 3 when the superconducting magnet 1 is equipped with an expandable part 42.

FIG. 5 is a cross-sectional view showing a superconducting magnet 2 according to a second embodiment.

FIG. 6 is a cross-sectional view showing the superconducting magnet 2 after cryogenic cooling.

FIG. 7 is a cross-sectional view showing a superconducting magnet 3 according to a third embodiment.

FIG. 8 is a cross-sectional view showing the superconducting magnet 3 after cryogenic cooling.

### DETAILED DESCRIPTION

A superconducting magnet according to an embodiment will now be described with reference to the drawings.

A superconducting magnet of an embodiment includes a cryogenic part, a heat shield, a thermal resistance part, and a heat capacity part. The cryogenic part includes a superconducting coil and is cooled by a cooling part. The heat shield covers the cryogenic part. The thermal resistance part is connected to a contacted part that is the cryogenic part or the heat shield. The heat capacity part connected to the thermal resistance part. The heat capacity part has a thermal contraction rate different from that of the contacted part. The heat capacity part is in thermal contact with the contacted part to a first degree at a first temperature. The heat capacity part is not in contact with the contacted part or is in thermal contact with the contacted part to a second degree less than the first degree at a second temperature higher than the first temperature. The thermal resistance part has a thermal resistance greater than that of a portion of the contacted part to which the thermal resistance part is connected.

### First Embodiment

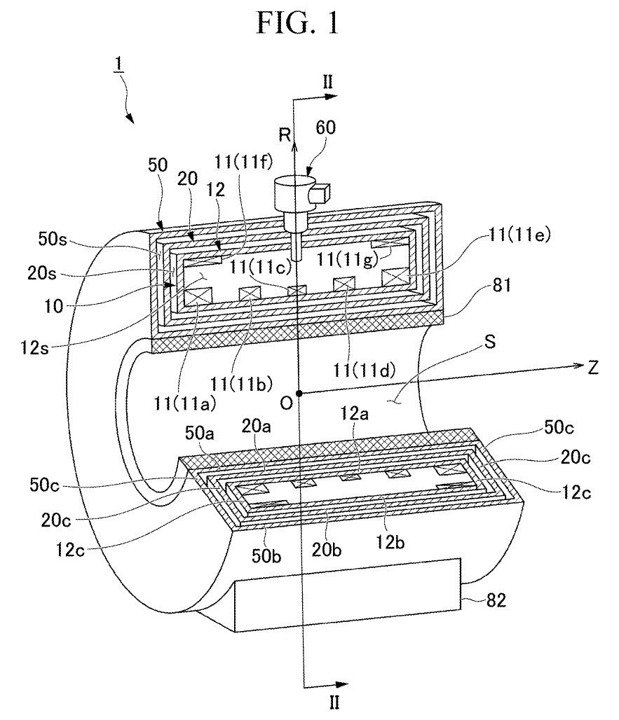

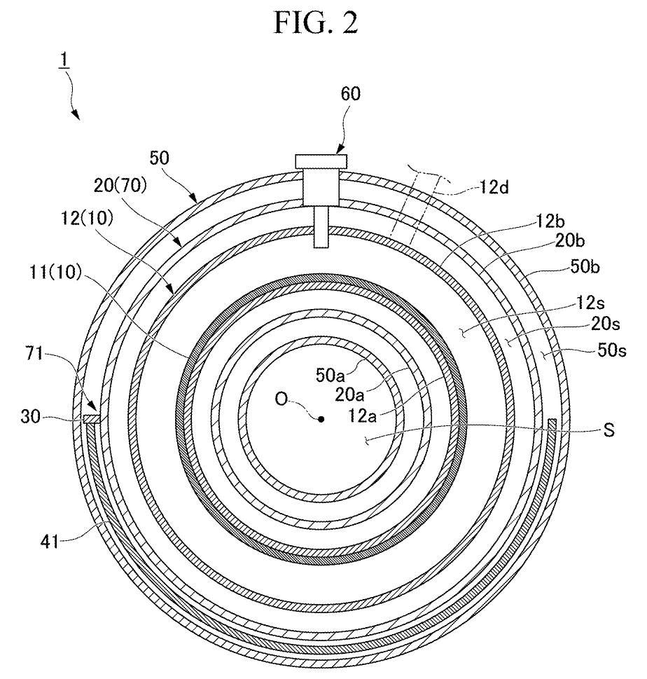

FIG. 1 is a diagram illustrating a superconducting magnet 1 according to a first embodiment. FIG. 2 is a cross-sectional view taken along line II-II in FIG. 1. FIG. 2 is a cross-sectional view illustrating the superconducting magnet 1 before cryogenic cooling. As shown in FIGS. 1 and 2, the superconducting magnet 1 has a roughly cylindrical shape. The superconducting magnet 1 may be used, for example, in a magnetic resonance imaging (MRI) device and the like. In this case, a space S enclosed by the cylindrical shape of the superconducting magnet 1 is used as an imaging region for imaging a subject.

In the following description, a direction parallel to the central axis O of the superconducting magnet 1 is referred to as a Z direction or axial direction Z. A cross section perpendicular to the axial direction Z is referred to as a transverse section. A direction orthogonal to the central axis O of the superconducting magnet 1 as viewed in the axial direction Z is referred to as a radial direction R. A direction approaching the central axis O in the radial direction R is referred to as an “inside” in the radial direction R, and a direction moving away from the central axis O is referred to as an “outside” in the radial direction R. A direction of rotating around the central axis O is referred to as a circumferential direction as viewed in the axial direction Z.

As shown in FIGS. 1 and 2, the superconducting magnet 1 includes a cryogenic part 10, a heat shield 20, a thermal resistance part 30, a heat capacity part 41, a vacuum vessel 50, and a cooling part 60. The thermal resistance part 30 and the heat capacity part 41 are not shown in FIG. 1.

The cryogenic part 10 includes at least one superconducting coil 11 (superconducting coils 11a to 11g in the example of FIG. 1) and a helium vessel 12. The cryogenic part 10 is cooled to a cryogenic temperature by the cooling part 60. “Cryogenic temperature” refers to, for example, a temperature below the superconducting transition temperature of the superconducting coil 11 (e.g., on the order of a few kelvins).

The superconducting coil 11 has a roughly circular shape with the central axis O as the central axis thereof. The superconducting coil 11 generates a magnetic field (e.g., a static magnetic field) in the space S. The cryogenic part 10 may include, for example, superconducting coils 11 (superconducting coils 11a to 11e in the example of FIG. 1) that forms a main magnetic field and superconducting coils 11 (superconducting coils 11f and 11g in the example of FIG. 1) that reduce leakage magnetic fields.

In the example of FIG. 1, the superconducting coils 11a to 11e are spaced apart in the axial direction Z. The superconducting coils 11f and 11g are spaced apart in the axial direction Z and are located outside the superconducting coils 11a to 11e in the radial direction R. However, the number and arrangement of the superconducting coils 11 included in the cryogenic part 10 may be changed as appropriate.

The helium vessel 12 has a roughly cylindrical shape with the central axis O as the central axis thereof. In the example of FIG. 1, the helium vessel 12 has an inner wall 12a, an outer wall 12b, and a pair of side walls 12c. The outer wall 12b is located on the outside the inner wall 12a in the radial direction R. The pair of side walls 12c extend in the radial direction R and connect both ends of the inner wall 12a in the axial direction Z to both ends of the outer wall 12b in the axial direction Z. The superconducting coils 11a to 11e are disposed along the inner wall 12a. The superconducting coils 11f and 11g are disposed along the outer wall 12b. However, the specific shape of the helium vessel 12 and the positional relationship between the helium vessel 12 and the superconducting coils 11 may be changed as appropriate.

The helium vessel 12 holds helium (liquid helium and gaseous helium). Helium is held in an internal space 12s of the helium vessel 12. In the example of FIG. 1, the internal space 12s is a space enclosed by the inner wall 12a, the outer wall 12b, and the pair of side walls 12c. The helium vessel 12 may have a pipe 12d for supplying helium to the internal space 12s and discharging helium from the internal space 12s.

The superconducting coils 11 are provided in the internal space 12s. In other words, the helium vessel 12 houses (contains) the superconducting coils 11. A bobbin (not shown) for wiring, disposing, and fixing the superconducting coils 11 may be provided in the internal space 12s. In this specification, the term “superconducting coil 11” may also refer to a configuration that includes both the coil body and the bobbin.

The helium held in the helium vessel 12 is cooled to a cryogenic temperature by the cooling part 60. The superconducting coils 11 housed in the helium vessel 12 are cooled to a cryogenic temperature by coming into contact with the cooled helium.

The heat shield 20 has a roughly cylindrical shape with the central axis O as the central axis thereof. In the example of FIG. 1, the heat shield 20 has an inner wall 20a, an outer wall 20b, and a pair of side walls 20c. The outer wall 20b is located outside the inner wall 20a in the radial direction R. The pair of side walls 20c extend in the radial direction R and connect both ends of the inner wall 20a in the axial direction Z to both ends of the outer wall 20b in the axial direction Z. However, the specific shape of the heat shield 20 may be changed as appropriate.

The heat shield 20 covers the cryogenic part 10 (helium vessel 12). That is, the heat shield 20 houses (contains) the cryogenic part 10 (helium vessel 12). In other words, the cryogenic part 10 (helium vessel 12) is disposed in an internal space 20s of the heat shield 20.

In the example of FIG. 1, the internal space 20s is a space enclosed by the inner wall 20a, the outer wall 20b, and the pair of side walls 20c. The inner wall 20a is located inside the inner wall 12a of the helium vessel 12 in the radial direction R. The outer wall 20b is located outside the outer wall 12b of the helium vessel 12 in the radial direction R. The pair of side walls 20c are located outside the pair of side walls 12c of the helium vessel 12 in the axial direction Z. Gaps are provided between the inner walls 12a and 20a, between the outer walls 12b and 20b, and between the side walls 12c and 20c.

The heat shield 20 serves to reduce heat penetration of radiant heat into the cryogenic part 10. For this reason, for example, a metal material with high heat transfer performance, such as an aluminum alloy (hereinafter also referred to as aluminum material) or a copper alloy (hereinafter also referred to as copper material) is typically used for the heat shield 20. A non-magnetic material may also be used for the heat shield 20.

The vacuum vessel 50 has a roughly cylindrical shape with the central axis O as the central axis thereof. In the example of FIG. 1, the vacuum vessel 50 has an inner wall 50a, an outer wall 50b, and a pair of side walls 50c. The outer wall 50b is located outside the inner wall 50a in the radial direction R. The pair of side walls 50c extend in the radial direction R and connect both ends of the inner wall 50a in the axial direction Z to both ends of the outer wall 50b in the axial direction Z. However, the specific shape of the vacuum vessel 50 may be changed as appropriate.

The vacuum vessel 50 covers the heat shield 20. That is, the vacuum vessel 50 houses (contains) the heat shield 20. In other words, the heat shield 20 is disposed in an internal space 50s of the vacuum vessel 50.

In the example of FIG. 1, the internal space 50s is a space enclosed by the inner wall 50a, the outer wall 50b, and the pair of side walls 50c. The inner wall 50a is located inside the inner wall 20a of the heat shield 20 in the radial direction R. The outer wall 50b is located outside the outer wall 20b of the heat shield 20 in the radial direction R. The pair of side walls 50c are located outside the pair of side walls 20c of the heat shield 20 in the axial direction Z. Gaps are provided between the inner walls 20a and 50a, between the outer walls 20b and 50b, and between the side walls 20c and 50c.

The vacuum vessel 50 maintains the internal space 50s at a vacuum. As a result, the components located within the internal space 50s (i.e., the heat shield 20 and the cryogenic part 10) are vacuum insulated.

A gradient magnetic field coil 81 (not shown in FIG. 2) for generating a gradient magnetic field in the space S may be provided inside the vacuum vessel 50 (inner wall 50a). A support 82 (not shown in FIG. 2) for supporting the vacuum vessel 50 may be provided outside the vacuum vessel 50 (outer wall 50b).

The cooling part 60 cools the cryogenic part 10. For example, the cooling part 60 cools the internal space 12s of the helium vessel 12 to a cryogenic temperature, thereby maintaining a thermal equilibrium state in which liquid helium and gaseous helium coexist in the internal space 12s. That is, by absorbing heat from the internal space 12s, the cooling part 60 suppresses evaporation of liquid helium and increase in the temperature of gaseous helium caused by external radiant heat and thermal conduction. This allows the cooling part 60 to maintain a constant temperature (e.g., cryogenic temperature) in the cryogenic part 10 and the heat shield 20.

The cooling part 60 may be, for example, a refrigeration system including an expander (cold head) and a compressor. The cooling part 60 is driven, for example, by power supplied from a power supply (not shown).

As shown in FIG. 2, the thermal resistance part 30 is connected to the heat shield 20. That is, the thermal resistance part 30 is in contact with the heat shield 20 and is fixed to the heat shield 20. Hereinafter, the object to which the thermal resistance part 30 is connected will be referred to as a contacted part 70. In the present embodiment, the contacted part 70 is the heat shield 20.

The thermal resistance part 30 is disposed on the opposite side to the cryogenic part 10 with respect to the heat shield 20. In other words, the thermal resistance part 30 is connected to the heat shield 20 (outer wall 20b) on the opposite side to the cryogenic part 10. Specifically, the thermal resistance part 30 is located outside the outer wall 20b of the heat shield 20 in the radial direction R. The thermal resistance part 30 is located between the outer wall 20b of the heat shield 20 and the outer wall 50b of the vacuum vessel 50 in the radial direction R.

The thermal resistance part 30 has a higher thermal resistance than that of a portion of the heat shield 20, which is the contacted part 70, to which the thermal resistance part 30 is connected (hereinafter referred to as a connection portion 71). The thermal resistance part 30 connects the connection portion 71 and the heat capacity part 41 and transfers heat between the connection portion 71 and the heat capacity part 41. The specific structure of the thermal resistance part 30 and the specific components constituting the thermal resistance part 30 may be changed as appropriate, as long as the thermal resistance part 30 has a higher thermal resistance than that of the connection portion 71 and is capable of connecting the connection portion 71 and the heat capacity part 41.

The heat capacity part 41 is connected to the thermal resistance part 30. That is, the heat capacity part 41 is in contact with the thermal resistance part 30 and is fixed to the thermal resistance part 30. In other words, the heat capacity part 41 is connected to the connection portion 71 via the thermal resistance part 30.

The heat capacity part 41 is disposed on the opposite side to the cryogenic part 10 with respect to the heat shield 20. That is, the heat capacity part 41 is located outside the outer wall 20b of the heat shield 20 in the radial direction R. Specifically, the heat capacity part 41 is located between the outer wall 20b of the heat shield 20 and the outer wall 50b of the vacuum vessel 50 in the radial direction R.

The heat capacity part 41 has a shape that follows the heat shield 20, which is the contacted part 70. Specifically, the heat capacity part 41 has a roughly arc shape (e.g., roughly semicircle) in cross-sectional view. One end of the arc-shaped heat capacity part 41 is connected to the thermal resistance part 30.

The heat capacity part 41 has a thermal contraction rate different from that of the heat shield 20, which is the contacted part 70. Specifically, the heat capacity part 41 has a greater thermal contraction rate than that of the heat shield 20. That is, the heat capacity part 41 contracts more than the heat shield 20 during cooling.

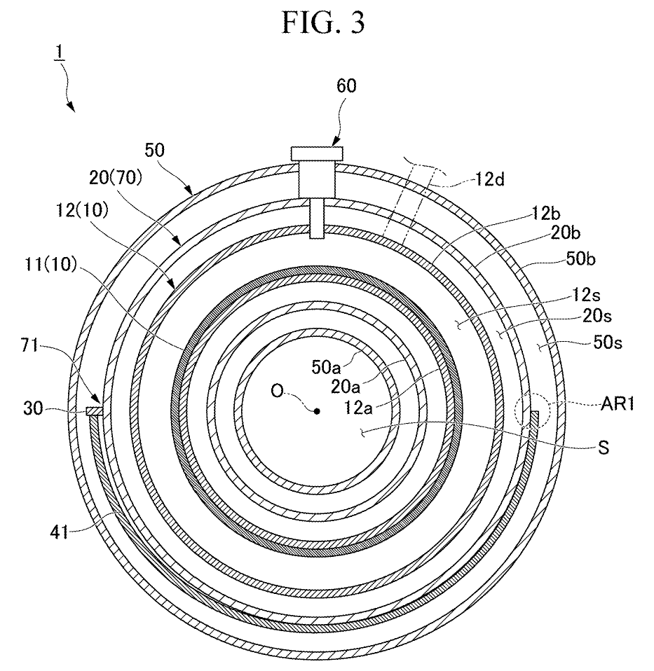

FIG. 3 is a cross-sectional view showing the superconducting magnet 1 after cryogenic cooling. As shown in FIG. 3, after cryogenic cooling (i.e., at a temperature below a first temperature), the heat capacity part 41 is in thermal contact with the heat shield 20, which is the contacted part 70, to a first degree.

The “first degree” and the “second degree” which will be described below are indicators of the magnitude of thermal contact (heat flow) between the contacted part 70 and the heat capacity part 41 and have values increasing as the thermal contact (heat flow) increases. In the example of FIG. 3, “thermal contact to the first degree” simply means “contact.” Furthermore, the “first temperature” is a temperature at which the heat capacity part 41 is in thermal contact with the contacted part 70 to the first degree due to the difference in thermal contraction rate between the heat capacity part 41 and the contacted part 70.

Since one end of the heat capacity part 41 is connected to the thermal resistance part 30, the heat capacity part 41 contracts with the thermal resistance part 30 as a fixed point. Therefore, after cryogenic cooling, the end of the heat capacity part 41 opposite the thermal resistance part 30 comes into contact with the contacted part 70.

On the other hand, as shown in FIG. 2, the heat capacity part 41 does not come into contact with the heat shield 20, which is the contacted part 70, before cryogenic cooling (i.e., at a temperature equal to or higher than a second temperature). Here, the “second temperature” is a temperature higher than the first temperature. The second temperature may be, for example, a temperature higher than the superconducting transition temperature of the superconducting coil 11 (e.g., room temperature). That is, in the present embodiment, due to the difference in thermal contraction rate between the heat capacity part 41 and the contacted part 70, a state in which the heat capacity part 41 and the contacted part 70 are in thermal contact with each other to the first degree and a state in which the heat capacity part 41 and the contacted part 70 are not in contact with each other are switched depending on the temperature.

When the cooling part 60 does not operate normally, such as when the power supply for driving the cooling part 60 is lost due to a power outage, after the superconducting magnet 1 has been cooled to a cryogenic temperature, the temperature of the internal space 12s of the helium vessel 12 may increase. In this case, evaporation of the liquid helium and increase in the temperature of the gaseous helium occur, causing an increase in the temperatures of the cryogenic part 10 and the heat shield 20.

To suppress such temperature increase, the heat capacity part 41 comes into contact (thermal contact to a first degree) with the heat shield 20, which is the contacted part 70, at a temperature equal to or lower than the first temperature. That is, when the heat capacity part 41 comes into contact with the heat shield 20, the heat capacity of the heat shield 20 increases, suppressing temperature increase in the heat shield 20 and the cryogenic part 10 housed therein. The specific shape and thermal contraction rate of the heat capacity part 41 and the materials constituting the heat capacity part 41 may be changed as appropriate, as long as it is possible to achieve thermal contact to the first degree based on the difference in thermal contraction rate between the heat capacity part 41 and the contacted part 70.

On the other hand, if the heat capacity of the cryogenic part 10 or the heat shield 20 is large, it becomes more difficult for the cryogenic part 10 or the heat shield 20 to cool, increasing the time required to cool the superconducting magnet 1 to a cryogenic temperature. To solve this problem, in the superconducting magnet 1, heat transfer between the heat capacity part 41 and the contacted part 70 (heat shield 20) is mediated by the thermal resistance part 30, which has a large thermal resistance.

When cooling by the cooling part 60 begins, the temperature of the contacted part 70 (heat shield 20) begins to decrease. The contacted part 70 absorbs heat from the heat capacity part 41 through the thermal resistance part 30, thereby cooling the heat capacity part 41 as well. Here, since the thermal resistance of the thermal resistance part 30 is greater than that of the connection portion 71, heat transfer from the heat capacity part 41 to the contacted part 70 is suppressed by the thermal resistance part 30. Therefore, the heat capacity part 41 cools more slowly than the contacted part 70. More specifically, the rate at which the temperature of the heat capacity part 41 decreases is lower than when the heat capacity part 41 is directly connected to the contacted part 70. As a result, the heat capacity part 41 remains at a higher temperature than the contacted part 70 for a while after cooling begins. Therefore, for a while after the start of cooling, the heat capacity part 41 does not reach the first temperature, and the heat capacity part 41 does not come into contact with the contacted part 70. As a result, the heat capacity of the heat shield 20, which is the contacted part 70, is kept low, and it is possible to ensure the efficiency of cooling by the cooling part 60.

After a sufficient amount of time has passed since cooling began, the heat of the heat capacity part 41 is absorbed by the contacted part 70, and the heat capacity part 41 and contacted part 70 reach a state of thermal equilibrium in which they are at approximately the same temperature. In this state of thermal equilibrium, the heat capacity part 41 reaches a temperature below the first temperature, and the heat capacity part 41 and the contacted part 70 come into contact with each other. This causes the heat capacity part 41 to increase the heat capacity of the contacted part 70 (heat shield 20), thereby achieving the temperature increase suppression effect described above.

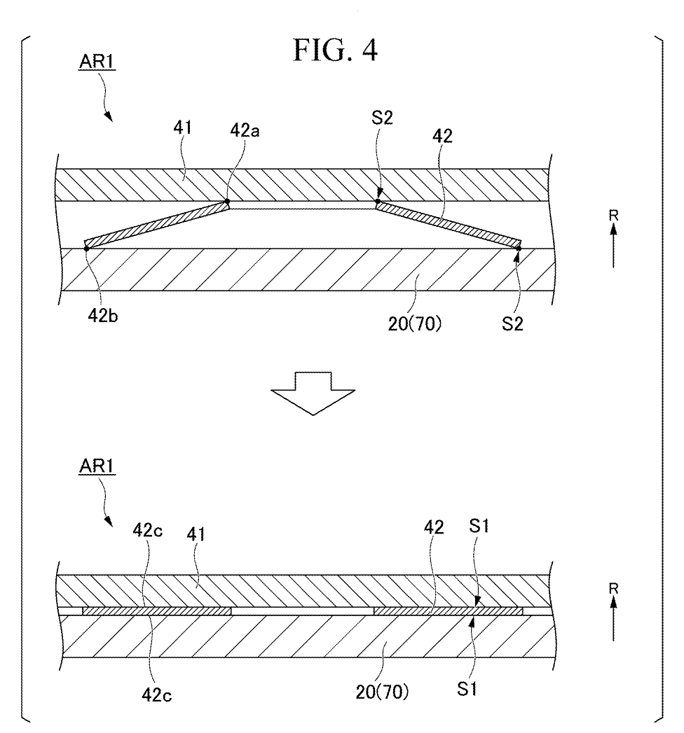

Here, an expandable part 42 may be provided in an area AR1 (refer to FIG. 3) where the heat capacity part 41 and the contacted part 70 (heat shield 20) come into contact with each other. FIG. 4 is an enlarged view of the area AR1 when the superconducting magnet 1 is equipped with the expandable part 42.

As shown in FIG. 4, the expandable part 42 is disposed between the heat capacity part 41 and the contacted part 70 (heat shield 20). The expandable part 42 expands and contracts in the opposing direction in which the heat capacity part 41 and the contacted part 70 are opposite each other. In the illustrated example, the opposing direction is the radial direction R. In the example of FIG. 4, the expandable part 42 is a disc spring.

The expandable part 42 exerts a biasing force in the opposing direction such that the heat capacity part 41 and the contacted part 70 move away from each other. The expandable part 42 comes into contact with both the heat capacity part 41 and the contacted part 70, thereby bringing the heat capacity part 41 and the contacted part 70 into thermal contact with each other.

Before cryogenic cooling (i.e., at a temperature equal to or higher than the second temperature), the expandable part 42 is in an expanded state. At this time, the expandable part 42 is in line contact with the heat capacity part 41 and the contacted part 70 along the upper and lower edges 42a and 42b of the expandable part 42, which is a disc spring. On the other hand, after cryogenic cooling (i.e., at a temperature equal to or lower than the first temperature), the heat capacity part 41 contracts more than the contacted part 70, thereby reducing the gap between the heat capacity part 41 and the contacted part 70 in the opposing direction. This causes the expandable part 42 to enter a contracted state. At this time, the expandable part 42 is in surface contact with the heat capacity part 41 and the contacted part 70 along the surfaces 42c (the surfaces that form the outer and inner surfaces of the cone) of the expandable part 42, which is a disc spring.

That is, the expandable part 42 expands and contracts depending on the temperature, which changes the contact area between the expandable part 42 and the heat capacity part 41 and the contacted part 70. Specifically, after cryogenic cooling (i.e., at a temperature equal to or lower than the first temperature), the expandable part 42 comes into contact with the heat capacity part 41 and the contacted part 70 over a first contact area S1. The first contact area S1 is an area where the surfaces 42c of the expandable part 42, which is a disc spring, come into contact (surface contact) with the heat capacity part 41 and the contacted part 70. On the other hand, before cryogenic cooling (i.e., at a temperature equal to or higher than the second temperature), the expandable part 42 comes into contact with the heat capacity part 41 and the contacted part 70 over a second contact area S2 that is smaller than the first contact area S1. The second contact area S2 is an area where the upper edge 42a and the lower edge 42b of the expandable part 42, which is a disc spring, come into contact (line contact) with the heat capacity part 41 and the contacted part 70.

This change in the contact area changes the degree of thermal contact between the heat capacity part 41 and the contacted part 70. That is, after cryogenic cooling (i.e., at a temperature equal to or lower than the first temperature), the expandable part 42 brings the heat capacity part 41 and the contacted part 70 into thermal contact to the first degree on the basis of the first contact area S1. On the other hand, after cryogenic cooling (i.e., at a temperature equal to or higher than the second temperature), the expandable part 42 brings the heat capacity part 41 and the contacted part 70 into thermal contact to the second degree less than the first degree on the basis of the second contact area S2. The second contact area S2 is smaller than the first contact area S1, and the smaller the contact area, the smaller the thermal contact (heat flow) between the heat capacity part 41 and the contacted part 70, and thus the second degree becomes less than the first degree.

In the superconducting magnet 1 equipped with the expandable part 42 described above, due to the difference in thermal contraction rate between the heat capacity part 41 and the contacted part 70 and expansion and contraction of the expandable part 42, a state in which the heat capacity part 41 and the contacted part 70 are in thermal contact with each other to the first degree and a state in which the heat capacity part 41 and the contacted part 70 are in thermal contact with each other to the second degree are switched depending on the temperature. Even with this configuration, it is possible to obtain the same effects as a configuration without the expandable part 42, that is, an increase in the heat capacity of the contacted part 70 after cryogenic cooling and ensuring cooling efficiency immediately after the start of cryogenic cooling. Furthermore, the expandable part 42 maintains the gap between the heat capacity part 41 and the contacted part 70, reducing the possibility of unintended contact between the heat capacity part 41 and the contacted part 70.

The expandable part 42 does not have to be a disc spring, as long as it is possible to change the degree of thermal contact between the heat capacity part 41 and the contacted part 70 by expansion and contraction. For example, the expandable part 42 may be a coil spring. In the case of a coil spring, for example, it is possible to change the degree of thermal contact between the heat capacity part 41 and the contacted part 70 by switching between contact and non-contact between windings included in the coil spring as the coil spring expands and contracts.

### Second Embodiment

Next, the second embodiment, which has a basic configuration similar to that of the first embodiment, will be described. Therefore, similar components are designated by the same reference numerals, description thereof will be omitted, and only the differences will be described.

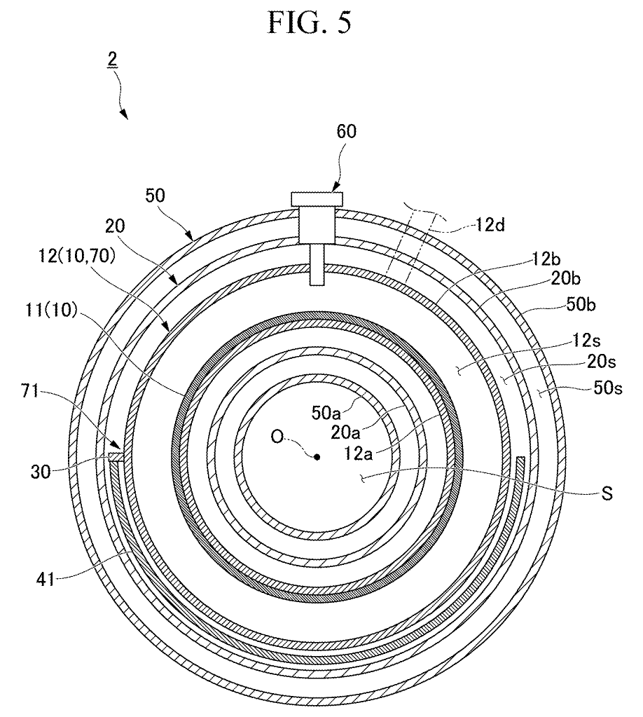

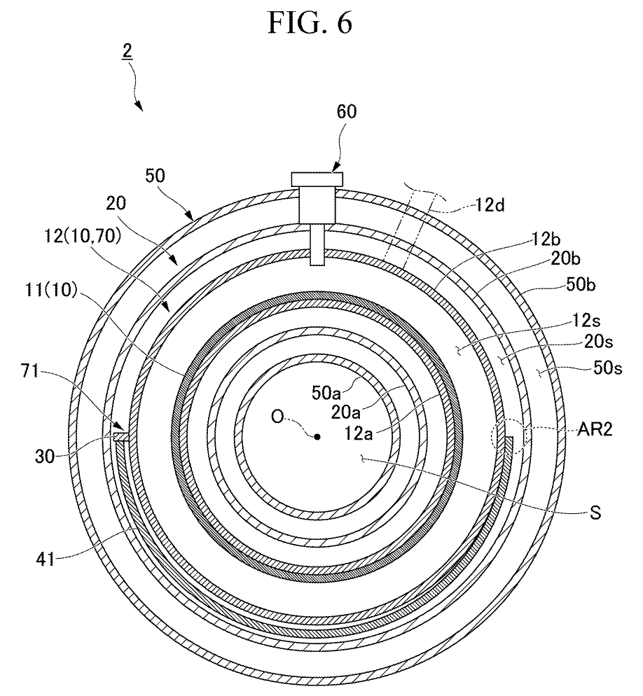

FIG. 5 is a cross-sectional view of a superconducting magnet 2 according to the second embodiment. FIG. 5 is a cross-sectional view of the superconducting magnet 2 before cryogenic cooling. FIG. 6 is a cross-sectional view of the superconducting magnet 2 after cryogenic cooling. As shown in FIGS. 2, 3, 5, and 6, the superconducting magnet 2 according to the second embodiment differs from the superconducting magnet 1 according to the first embodiment with respect to the configurations of the thermal resistance part 30 and the heat capacity part 41.

In the present embodiment, the thermal resistance part 30 and the heat capacity part 41 are disposed between the heat shield 20 and the cryogenic part 10 (helium vessel 12). Specifically, the thermal resistance part 30 and the heat capacity part 41 are located inside the outer wall 20b of the heat shield 20 in the radial direction R. The thermal resistance part 30 and the heat capacity part 41 are located outside the outer wall 12b of the helium vessel 12 in the radial direction R.

Furthermore, the thermal resistance part 30 according to the present embodiment is connected to the helium vessel 12 (cryogenic part 10) rather than the heat shield 20. That is, the thermal resistance part 30 is in contact with the helium vessel 12 and is fixed to the helium vessel 12. That is, in the present embodiment, the contacted part 70 is the helium vessel 12 (cryogenic part 10). The thermal resistance part 30 has a greater thermal resistance than that of the connection portion 71 of the helium vessel 12 (cryogenic part 10).

The heat capacity part 41 according to the present embodiment has a greater thermal contraction rate than that of the helium vessel 12 (cryogenic part 10), which is the contacted part 70. That is, the heat capacity part 41 according to the present embodiment contracts more than the helium vessel 12 when cooled.

As shown in FIG. 6, after cryogenic cooling (i.e., at a temperature equal to or lower than the first temperature), the heat capacity part 41 contracts more than the helium vessel 12 (cryogenic part 10), which is the contacted part 70, thereby bringing the heat capacity part 41 into thermal contact with the contacted part 70 to the first degree. As a result, similar to the first embodiment, the heat capacity part 41 increases the heat capacity of the contacted part 70 after cryogenic cooling, thereby suppressing a temperature increase in the cryogenic part 10. Furthermore, similar to the first embodiment, it is possible to ensure the thermal resistance part 30 cooling efficiency immediately after the start of cryogenic cooling. Although detailed illustration is omitted, the superconducting magnet 2 according to the present embodiment may also be equipped with the expandable part 42 in an area AR2 where the heat capacity part 41 and the contacted part 70 (helium vessel 12) come into contact with each other, similar to the superconducting magnet 1 according to the first embodiment.

### Third Embodiment

Next, the third embodiment, which has a basic configuration similar to that of the second embodiment, will be described. Therefore, the same components are denoted by the same reference numerals, description thereof will be omitted, and only the differences will be described.

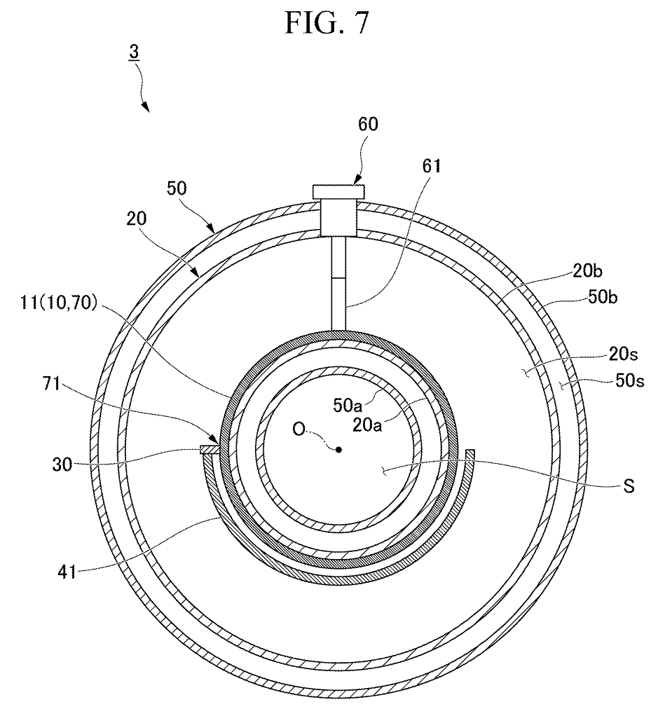

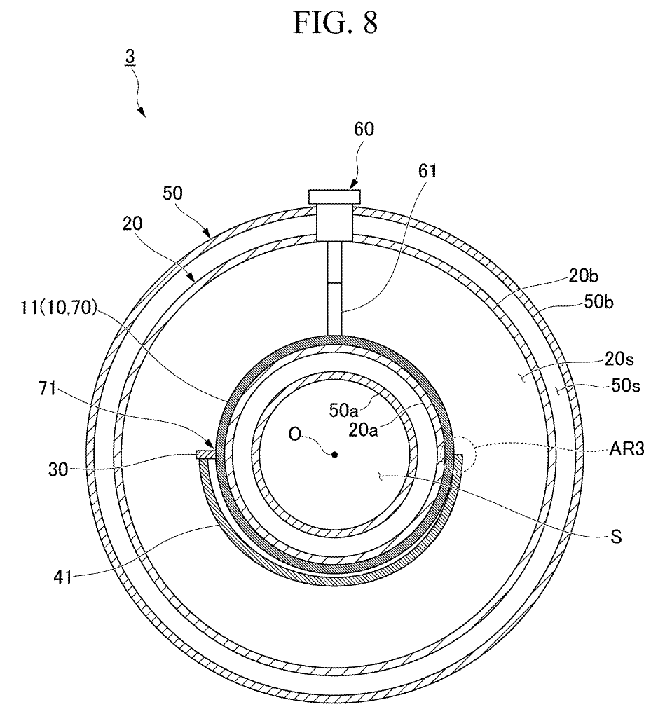

FIG. 7 is a cross-sectional view of a superconducting magnet 3 according to the third embodiment. FIG. 7 is a cross-sectional view of the superconducting magnet 3 before cryogenic cooling. FIG. 8 is a cross-sectional view of the superconducting magnet 3 after cryogenic cooling. As shown in FIGS. 5, 6, 7, and 8, the superconducting magnet 3 according to the third embodiment differs from the superconducting magnet 2 according to the second embodiment with respect to the configuration of the cryogenic part 10.

In the present embodiment, the cryogenic part 10 does not include the helium vessel 12. In other words, there is no helium vessel 12 between the superconducting coil 11 and the heat shield 20. The superconducting coil 11 is directly housed in the heat shield 20 and disposed in the internal space 20s of the heat shield 20. As a result, the superconducting coil 11 is disposed in the vacuum created by the vacuum vessel 50 rather than in helium. The position at which the superconducting coil 11 is disposed in the internal space 20s is not particularly limited, but the superconducting coil 11 may be disposed along the inner wall 20a of the heat shield 20, for example.

In the present embodiment, the cooling part 60 and the superconducting coil 11 are mechanically connected by a heat transfer member 61. The heat transfer member 61 mediates heat transfer between the cooling part 60 and the superconducting coil 11. In the present embodiment, the superconducting coil 11 is cooled to a cryogenic temperature by the cooling part 60 absorbing heat from the superconducting coil 11 via the heat transfer member 61. That is, the superconducting coil 11 according to the present embodiment is cooled (conduction cooled) not by contact with helium, but by contact with the heat transfer member 61 connected to the cooling part 60. The heat transfer member 61 may be included in the cryogenic part 10. That is, it is also possible to interpret that the cryogenic part 10 according to the present embodiment includes the heat transfer member 61 instead of the helium vessel 12.

Furthermore, the thermal resistance part 30 according to the present embodiment is connected to the superconducting coil 11. That is, the thermal resistance part 30 comes into contact with the superconducting coil 11 and is fixed to the superconducting coil 11. That is, in the present embodiment, the contacted part 70 is the superconducting coil 11. The thermal resistance part 30 has a greater thermal resistance than that of the connection portion 71 of the superconducting coil 11.

The heat capacity part 41 according to the present embodiment has a greater thermal contraction rate than that of the superconducting coil 11, which is the contacted part 70. That is, the heat capacity part 41 according to the present embodiment contracts more than the superconducting coil 11 when cooled.

As shown in FIG. 8, after cryogenic cooling (i.e., at a temperature equal to or lower than the first temperature), the heat capacity part 41 contracts more than the superconducting coil 11, which is the contacted part 70, and thus the heat capacity part 41 comes into thermal contact with the contacted part 70 to the first degree. As a result, similar to the second embodiment, the heat capacity part 41 increases the heat capacity of the contacted part 70 after cryogenic cooling, thereby suppressing a temperature increase in the cryogenic part 10 (superconducting coil 11). Furthermore, similar to the second embodiment, the thermal resistance part 30 ensures cooling efficiency immediately after the start of cryogenic cooling. Although detailed illustration is omitted, the superconducting magnet 3 according to the present embodiment may also be equipped with the expandable part 42 in an area AR3 where the heat capacity part 41 and the contacted part 70 (superconducting coil 11) come into contact with each other, similar to the superconducting magnet 2 according to the second embodiment.

### Modified Examples

In the first embodiment described above, the cryogenic part 10 includes the helium vessel 12, but the cryogenic part 10 does not necessarily have to include the helium vessel 12. In this case, as in the third embodiment, the cryogenic part 10 may include the heat transfer member 61 that mediates heat transfer between the cooling part 60 and the superconducting coil 11, instead of the helium vessel 12. Furthermore, in the superconducting magnet 3 according to the third embodiment, the thermal resistance part 30 may be connected to the heat transfer member 61 or the like. In other words, the connection portion 71 may be located on the heat transfer member 61 or the like.

According to at least one embodiment described above, it is possible to achieve both suppression of temperature increase when the cooling part 60 does not operate normally and ensuring of cooling efficiency by including the cryogenic part 10 including the superconducting coil 11 and cooled by a cooling part 60, the heat shield 20 covering the cryogenic part 10, the thermal resistance part 30 connected to the contacted part 70 that is the cryogenic part 10 or the heat shield 20, and the heat capacity part 41 connected to the thermal resistance part 30, wherein the heat capacity part 41 has a thermal contraction rate different from that of the contacted part 70, the heat capacity part 41 is in thermal contact with the contacted part 70 to the first degree at the first temperature, the heat capacity part 41 is not in contact with the contacted part 70 or is in thermal contact with the contacted part 70 to the second degree less than the first degree at the second temperature higher than the first temperature, and the thermal resistance part 30 has a higher thermal resistance than that of the portion of the contacted part 70 to which the thermal resistance part 30 is connected (connection portion 71).

Although several embodiments have been described, these embodiments are presented as examples and are not intended to limit the scope of the invention. These embodiments may be implemented in various other forms, and various omissions, substitutions, and modifications may be made without departing from the spirit of the invention. These embodiments and modifications thereof are included in the scope and spirit of the invention, as well as the scope of the invention described in the claims and equivalents thereof.

What is claimed is:

1. A superconducting magnet comprising:
a cryogenic part including a superconducting coil and cooled by a cooling part;
a heat shield covering the cryogenic part;
a thermal resistance part connected to a contacted part that is the cryogenic part or the heat shield; and
a heat capacity part connected to the thermal resistance part,
wherein the heat capacity part has a thermal contraction rate different from a thermal contraction rate of the contacted part,
the heat capacity part is in thermal contact with the contacted part to a first degree at a first temperature,
the heat capacity part is not in contact with the contacted part or is in thermal contact with the contacted part to a second degree less than the first degree at a second temperature higher than the first temperature, and
the thermal resistance part has a thermal resistance greater than a thermal resistance of a portion of the contacted part to which the thermal resistance part is connected.

2. The superconducting magnet according to claim 1, further comprising an expandable part disposed between the heat capacity part and the contacted part, bringing the heat capacity part and the contacted part into thermal contact, and expanding and contracting in a direction in which the heat capacity part and the contacted part are opposite each other,
wherein the expandable part contracts at the first temperature, thereby bringing the heat capacity part and the contacted part into thermal contact to the first degree, and the expandable part expands at the second temperature, thereby bringing the heat capacity part and the contacted part into thermal contact to the second degree.

3. The superconducting magnet according to claim 2, wherein the expandable part is a disc spring.

4. The superconducting magnet according to claim 1, wherein the contacted part is the heat shield,
wherein the heat capacity part is disposed on the opposite side to the cryogenic part with respect to the heat shield, and the heat capacity part has a greater thermal contraction rate than a thermal contraction rate of the heat shield.

5. The superconducting magnet according to claim 1, wherein the contacted part is the cryogenic part,
wherein the heat capacity part is disposed between the heat shield and the cryogenic part, and the heat capacity part has a greater thermal contraction rate than a thermal contraction rate of the cryogenic part.

6. The superconducting magnet according to claim 5, wherein the contacted part is the superconducting coil,
wherein the heat capacity part is disposed between the heat shield and the superconducting coil, and the heat capacity part has a greater thermal contraction rate than a thermal contraction rate of the superconducting coil.

7. The superconducting magnet according to claim 6, wherein the superconducting coil is cooled by heat being absorbed by the cooling part via a heat transfer member connecting the cooling part and the superconducting coil.
